(19) United States
(12) Patent Application Publication
(10) Pub. No.: US 2010/0070526 A1
(43) Pub. Date: Mar. 18, 2010

(54) Method and system for producing a web snapshot

(75) Inventor: Joven Michael Matias, Pasadena, CA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISES, INC., BURBANK, CA (US)

(21) Appl. No.: 12/283,819

(22) Filed: Sep. 15, 2008

(51) Int. Cl. G06F 17/30

(52) U.S. Cl. 707/770; 707/E17.014

(57) ABSTRACT

There is provided a method for producing a web snapshot, comprising determining a search subject from a received input, designating a plurality of content sources on which to search for contents relating to the search subject, and executing a respective search protocol for each of the plurality of content sources. The method further comprises selecting the contents found on each of the plurality of content sources according to a time associated with each of the contents, and composing a viewing pane including a visual representation and a location for each of a predetermined number of the selected contents from each of the plurality of content sources. The method includes applying a time stamp to the viewing pane to produce of web snapshot. In one embodiment, the method is performed according to instructions stored on a computer-readable medium.

### BACKGROUND OF THE INVENTION

1. Field of the Invention

The present invention relates generally to providing computer systems and communications. More particularly, the present invention relates to computer mediated access to network-based information content.

2. Background Art

As may be apparent to anyone who has searched for content on the World Wide Web (web), the greatest challenge to the web user of today is not so much finding content, as it is coping with overabundance of content. Despite the vast information resources now a mere mouse click away, and, paradoxically perhaps, because of their ready accessibility, those of us living in the information age may find ourselves as frustrated as ever before in our attempts to obtain timely and personally interesting content. Unlike the situation in the past, however, the problems of the present are grounded not in the scarcity of a precious resource, but rather in the need to distill the useful or desirable from that which may be plentiful, but constitutes little of genuine interest to the user.

Common experience may show that extracting content that is personally desirable from the much greater body of content that is not, can be a demanding and sometimes unpleasantly burdensome undertaking. The active efforts required to differentiate among alternative items of content to distinguish value from superficiality, and timeliness from obsolescence, may dissipate user interest, and in the process, squander the user's time. As a result, the potential wealth of information continuously available to users via the web is rendered far less useful than it might otherwise be, simply because there is so much of it.

A natural if ultimately unproductive human reaction to the frustration associated with content overload, is to avoid its stress and confusion by turning away from the web as a preferred content source. While perhaps effective in avoiding the personal inconveniences created by having to actively contend with the abundance of content available online, that approach is at the very least intellectually regressive. Moreover, by turning away from online resources, the user fails to enjoy the potential benefits obtainable from a selective harvesting of the wealth of information made available by the advances in communication technology that are a hallmark of our time.

A more measured conventional approach to solving the problems of content overload utilizes standard computer based content management tools, such as a commercial web search engine, for example, to sort and summarize available content, by subject matter or otherwise. This approach allows the user to more rapidly discriminate among available content to evaluate the likelihood that particular items align with their personal interests. A significant disadvantage of this widely implemented conventional solution, however, is that it may require a considerable amount of user sophistication for implementation of an effective search strategy. Moreover, because the user may still be required to read or view numerous synopses or other renderings of content that is stale, only marginally relevant to user interest, or otherwise undesired, this conventional approach continues to impose significant burdens on user time and attention.

Furthermore, widely available conventional tools for locating web content often search for content in a specific presentation format, to the exclusion of others. For example, a user may be required to specify a content presentation format such as graphical images, videos, or text feeds prior to initiating a search, and then only content in that selected presentation format is returned. A user utilizing such a solution may wish to view content spanning more than one presentation format, but be required to perform multiple searches in order to do so.

Accordingly, there is a need to overcome the drawbacks and deficiencies in the art by providing a solution that enables a user to selectively sample new, timely web content relevant to a subject matter of interest to them, across a variety of presentation formats.

### SUMMARY OF THE INVENTION

There are provided methods and systems for producing a web snapshot, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of an exemplary system for producing a web snapshot, according to one embodiment of the present invention;

FIG. 2 shows a more detailed exemplary embodiment of a system for producing a web snapshot, according to one embodiment of the present invention;

FIG. 3 is a flowchart presenting a method for producing a web snapshot, according to one embodiment of the present invention; and

FIG. 4 shows an exemplary viewing pane of a web snapshot capturing relevant content corresponding to the American Broadcasting Company (ABC) television program Grey's Anatomy, produced according to one embodiment of the present invention.

### DETAILED DESCRIPTION OF THE INVENTION

The present application is directed to a method and system for producing a web snapshot. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals.

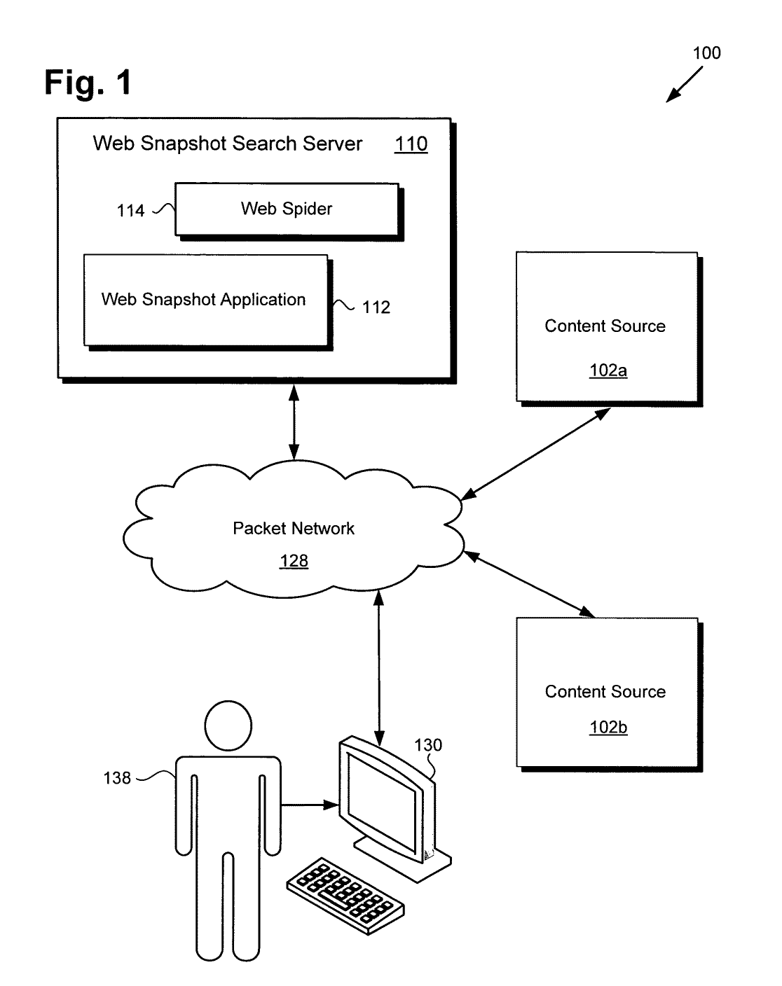

FIG. 1 shows a diagram of exemplary system 100 for producing a web snapshot, according to one embodiment of the present invention. In the embodiment of FIG. 1, system 100 comprises web snapshot search server 110 including web snapshot application 112 and web spider 114. Also shown in FIG. 1 are content sources 102a and 102b, packet network 128, client computer 130, and user 138. According to the embodiment of FIG. 1, user 138 may utilize web snapshot application 112, which may be downloaded to client computer 130 over packet network 128, for example, to search for web content on content sources 102a and 102b. In some instances user 138 may utilize web snapshot application 112 to search content source 102a or 102b directly, for example, by means of an application programming interface (API) provided by content source 102a or 102b. In other instances, web snapshot application 112 may utilize web spider 114, residing on web snapshot search server 110, to perform some or all of the web search.

Web snapshot application 112 may be configured to produce a web snapshot of the most recently created or updated web content relevant to a subject matter of interest to user 138, for example. In one embodiment, web snapshot application 112 may be configured to determine a search subject matter, i.e., a subject matter of interest to user 138, from a search query or other input provided by user 138. Having determined the search subject matter, web snapshot application 112 may be further configured to designate a plurality of content sources on which to search for contents relating to the search subject matter, such as content sources 102a and 102b, in FIG. 1.

According to one embodiment, web snapshot application 112 is configured to adopt search protocols appropriate to the content sources being searched, and execute those search protocols to examine each of the content sources designated for the search. For example, where the content sources designated for searching include one or more commercial web search engines, corresponding appropriate search protocols may comprise sending key data to the respective APIs provided by the commercial search sources. By contrast, where the content sources designated for searching include primary sources of content, such as web sites devoted to news, sports, or fashion, or commercial entertainment websites, for example, an appropriate search strategy may be implemented by web snapshot application 112, using search spider 114. As shown in FIG. 1, search spider 114 is a resource local to web snapshot search server 110, and is configured to operate under the direct control of web snapshot application 112.

Because web snapshot application 112 is configured to adopt the search protocols appropriate to the content sources designated for search, several search protocols may be utilized concurrently. As a result, web snapshot application 112 is capable of producing a web snapshot having content in more than one presentation format. Thus, contents related to the search subject provided as text feeds, through Really Simple Syndication (RSS) data feeds or Atom feeds, for example, may be included in a web snapshot along with contents related to the search subject provided as graphical images and/or video content, for instance.

Web snapshot application 112 is further configured to select the contents found on the various content sources according to a time associated with each of the contents. Web snapshot application 112 may then compose a viewing pane including a visual representation and a location corresponding to each of a predetermined number of the selected contents from each of the content sources searched, and apply a time stamp to the viewing pane to produce the web snapshot for user 138. In some embodiments, the number of contents from each content source to be included on the viewing pane may be predetermined by user 138. In other embodiments, that number may be predetermined by web snapshot application 112.

As described in reference to FIG. 1, user 138 may utilize client computer 130 to access web snapshot application 112 and produce a web snapshot. In one embodiment, for example, the user may be provided with a representation of the most recently created or updated contents relating to a subject matter of interest to them. The user may make use of the web snapshot in several ways. For example, the user may navigate to one or more of the contents included on the viewing pane and advantageously access one of the most timely contents relating to their area of interest presently available on the web. Alternatively, the user may save the web snapshot locally, for example on client computer 130, or in some embodiments the web snapshot may be associated with a user account and stored remotely on web snapshot search server 110. It is noted that although client computer 130 is represented as a personal computer (PC) in the embodiment of FIG. 1, in one embodiment client computer 130 may comprise a mobile communication device such as a tablet computer, mobile telephone, personal digital assistant (PDA), gaming console, or digital media player, for example.

Because user 138 may utilize client computer 130 and web snapshot application 112 to obtain fresh, timely web content across a variety of presentation formats concurrently, the user is able to track the popular media “buzz” surrounding a subject. For example, user 138 may track the buzz surrounding a subject matter of interest by noting the distribution and/or quantity of fresh content devoted to that subject as text feeds, graphical images, and videos. In addition, because the web snapshots may be stored, user 138 may access their stored archive of web snapshots and select a web snapshot for purposes of comparison with other web snapshots produced either earlier, later, or both, to track the evolution of available web content devoted to their special interest.

Furthermore, in some embodiments, web snapshot application 112 may be configured to enable user 138 to implement a method for surveying a plurality of web snapshots sharing a common search subject, more or less concurrently. In those embodiments, for example, web snapshot application 112 may be used to group and organize web snapshots after their production, so that web snapshots sharing a common search subject might be stored and retrieved collectively, rather than individually. In that way, web snapshot application 112 may enable user 138 to observe the change in media interest and/or coverage of the shared search subject over time, much as surveying a succession of historical newspaper front page images may be representative of public preoccupation with a particular subject matter in the past.

As shown in FIG. 1, web snapshot application 112 and web spider 114 may be accessed through packet network 128. In that instance, web snapshot application 112 may comprise a web application, accessible over a packet network such as the Internet, configured to execute as a server based application on web snapshot search server 110, for example. Alternatively, web snapshot application 112 and web spider 114 may reside on a server supporting a local area network (LAN), or be included in another type of limited distribution network. In another embodiment, web snapshot application 112 may be stored on a portable computer-readable medium such as a compact disc read-only memory (CD-ROM).

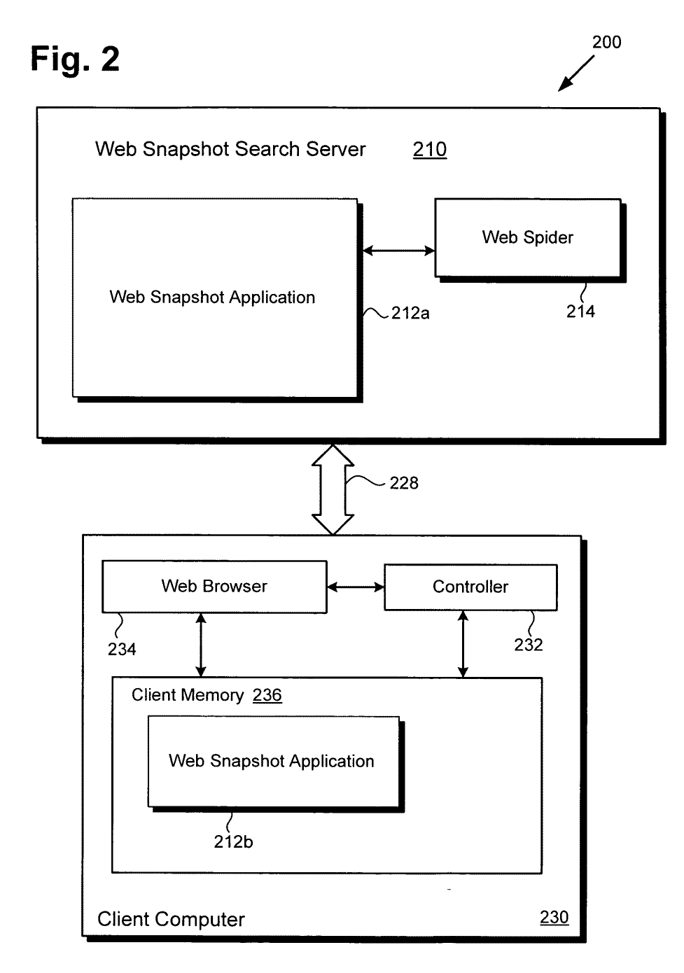

Turning now to FIG. 2, FIG. 2 shows a more detailed exemplary embodiment of system 200 for producing a web snapshot, according to one embodiment of the present invention. System 200 in FIG. 2 includes client computer 230 receiving a download via communication link 228 from web snapshot search server 210. Web snapshot search server 210 is shown to include web snapshot application 212a and web spider 214, and corresponds respectively to web snapshot search server 110 including web snapshot application 112 and web spider 114, in FIG. 1. Moreover, client computer 230 corresponds to client computer 130, in FIG. 1. As shown in FIG. 2, client computer 230 comprises controller 232, web browser 234, and client memory 236. Also shown in FIG. 2 is web snapshot application 212b, on client computer 230.

According to the embodiment of FIG. 2, web snapshot application 212b is located in client memory 236, having been received from web snapshot search server 210 via communication link 228. In one embodiment, communication link 228 represents download of web snapshot application 212a over a packet network, for example. Once transferred, web snapshot application 212b may be stored in client memory 236 and run locally on client computer 230, as a desktop application, for example. It is noted that communication link 228 is shown as a two-way communication, to represent ongoing communication between web snapshot application 212b and web spider 214 on web snapshot search server 210.

Alternatively, web snapshot application 212a can reside on a computer-readable medium compatible with client computer 230. For example, instructions comprising web snapshot application 212b which, when executed by client computer 230, perform a method for producing a web snapshot may reside on the computer-readable medium. The method performed in response to the computer-readable medium stored instructions may include determining a search subject from a received input, designating a plurality of content sources on which to search for relevant content corresponding to the search subject, executing a respective search protocol for finding contents relating to the search subject on each of the plurality of content sources, selecting the contents found on each of the plurality of content sources according to a time associated with each of the contents, composing a viewing pane including a visual representation and a location for each of a predetermined number of the selected contents from each of the plurality of content sources, and applying a time stamp to the viewing pane to produce the web snapshot.

The expression “computer-readable medium,” as used in the present application, refers to any medium that provides instructions to controller 232 of client computer 230. Thus, a computer-readable medium may correspond to various types of media, such as volatile media, non-volatile media, and transmission media, for example. Volatile media may include dynamic memory, such as dynamic random access memory (dynamic RAM), while non-volatile memory may include optical, magnetic, or electrostatic storage devices. Transmission media may include coaxial cable, copper wire, or fiber optics, for example, or may take the form of acoustic or electromagnetic waves, such as those generated through radio frequency (RF) and infrared (IR) communications. Common forms of computer-readable media include, for example, a CD-ROM, digital video disc (DVD), or other optical disc; a RAM, programmable read-only memory (PROM), erasable PROM (EPROM), FLASH memory, or a transmission carrier wave.

Controller 232 may be the central processing unit for client computer 230, for example, in which role controller 232 runs the client computer operating system, launches web browser 234, and facilitates use of web snapshot application 212b. Web browser 234, under the control of controller 232, may execute web snapshot application 212b and display a viewing pane composed by web snapshot application 212b, to enable a user of client computer 230 to identify fresh, timely web content relevant to a subject matter of interest to them.

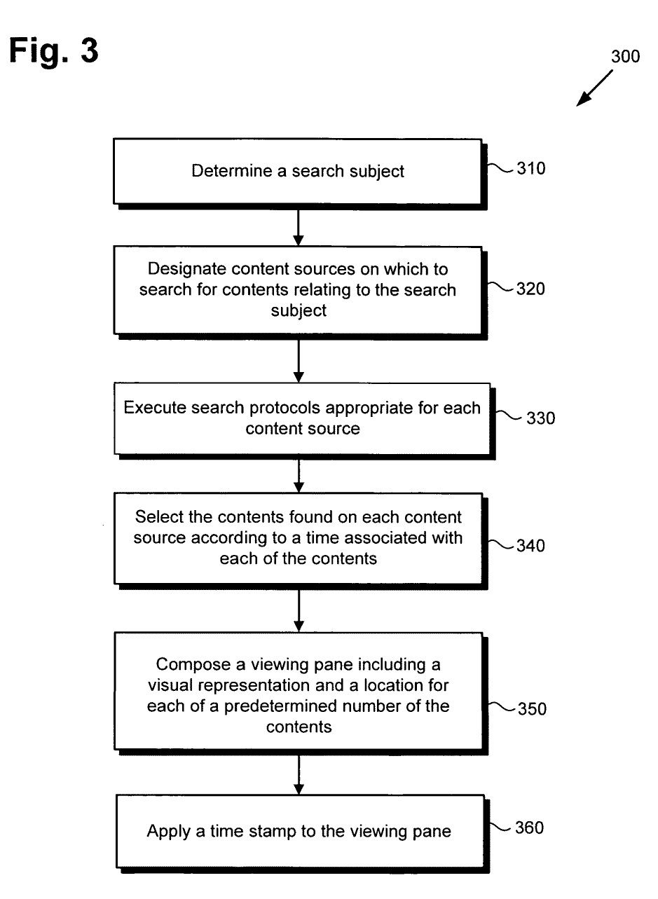

FIGS. 1 and 2 will now be further described in conjunction with FIG. 3, which presents flowchart 300, showing an example method for producing a web snapshot, according to one embodiment of the present invention. Certain details and features have been left out of flowchart 300 that are apparent to a person of ordinary skill in the art. For example, a step may consist of one or more substeps or may involve specialized equipment or materials, as known in the art. While steps 310 through 360 indicated in flowchart 300 are sufficient to describe one embodiment of the present method, other embodiments may utilize steps different from those shown in flowchart 300, or may include more, or fewer steps.

Beginning with step 310 in FIG. 3 and system 100 in FIG. 1, step 310 of flowchart 300 comprises determining a search subject. Determination of a search subject in step 310 may be performed by web snapshot application 112, according to an input received from user 138, for example. As was noted earlier, client computer 130 utilized by user 138 may be selected from a variety of personal communication devices and systems, as previously described. Consequently, user 138 may employ a corresponding variety of possible local inputs, such as mouse commands, touch screen commands, keyboard commands, and the like, to provide the inputs allowing web snapshot application 112 to determine a search subject in step 310.

The search subject determined in step 310 may be a general subject matter category, such as sports, news, fashion, or entertainment, for example. In one embodiment, the search subject may comprise an entertainment genre, such as television programming or movies, for example. In one embodiment, the search subject may comprise a particular television program, or movie. In another embodiment, the search subject may comprise an entertainment artist, or a dramatic persona. For example, the search subject may be determined to be one or both of the characters of Dr. Meredith Grey and/or Dr. Derek Shepherd of the American Broadcasting Company (ABC) television drama Grey's Anatomy, or, alternatively, the program Grey's Anatomy itself.

The exemplary method of flowchart 300 continues with step 320, which comprises designating a plurality of content sources on which to search for contents relating to the search subject. Designation of the plurality of content sources on which to search may be performed by web snapshot application 112. As explained earlier in reference to FIG. 1, content sources may include commercial web search engines and/or primary sources of news, sports, fashion, or entertainment content, for example. In one embodiment of the present invention, the content sources designated by web snapshot application in step 320 include a plurality of commercial web search engines. In that and other embodiments, the content sources designated for search may also include one or more commercial entertainment websites.

In some embodiments, designation of the content sources to be searched is an automated step performed by web snapshot application 112, independently of user 138. In some of those embodiments, the plurality of content sources may be predetermined, i.e., coded into web snapshot application 112. In other embodiments in which step 320 is performed independently of user input, designation of the content sources may be a more dynamic process, for example one controlled by an algorithm using the search subject determined in step 310 as a variable. In other embodiments, however, designation of content sources for searching in step 320 may be an interactive process in which web snapshot application is configured to accept one or more content source selections from the user.

Flowchart 300 continues with step 330, comprising executing a respective search protocol for finding the contents on each of the plurality of content sources. Step 330 may be performed by web snapshot application 112 alone, or by web spider 114 under the direct control of web snapshot application 112. As explained previously in relation to FIG. 1, search of a commercial web search engine may be performed by web snapshot application 112 alone, through interaction with an API provided by the commercial web search engine. In situations in which web snapshot application has designated primary sources of web content as content sources to search, either in place of, or in addition to commercial web search engines, however, the respective appropriate search protocols may include use of web spider 114. In those latter situations, web snapshot application 112 can be used to control web spider 114 in order to implement a search for contents relating to the search subject on each of the primary sources, such as commercial news, sports, or entertainment websites, and thus harvest contents from those content sources.

The search protocols executed by web snapshot application 112 may also differ according to the various respective presentation formats in which the contents are being sought. For example, web snapshot application 112 may be configured to implement a first search protocol for contents embodied as data or text feeds, a second search protocol for contents embodied as graphical images, and yet a third search protocol for relevant video contents, for example. As a result of this flexibility of approach, the present method enables user 138 to utilize web snapshot application 112 to examine contents relating to the search subject across a wide variety of presentation formats.

Moving on to step 340 of flowchart 300, step 340 comprises selecting the contents found on each content source according to a time associated with the contents. In one embodiment, selecting the contents may include ranking the content found on each of the content sources. The selected contents on each content source may be sorted and ranked by web snapshot application 112, for example, on the basis of how recently each of the contents was created or updated. In that embodiment, ranking may result in the most recently created or updated contents from each content source being ranked first, the second most recently created or updated contents from each content source being ranked second, and so on. In other embodiments in which ranking occurs, however, ranking may be performed relative to a designated target occasion, such as a particular time and/or date. In those embodiments ranking might proceed according to proximity of the target occasion to the time at which each of the contents relating to the search subject was created or most recently updated, for example.

Step 350 of flowchart 300 comprises composing a viewing pane including a visual representation and a location for each of a predetermined number of the selected contents from each of the plurality of content sources. Step 350 may be performed by web snapshot application 112, and may correspond, for example, to providing user 138 with visual recognition cues and links to the freshest contents presently available on the web. One of the numerous advantages provided by the present invention is that identification of web content having enhanced desirability to a user by virtue of its newness, becomes more intuitive for the user. One of the ways that this advantage is achieved, is by converting the analytical identification of content required by many conventional approaches, which typically require scanning of a digest entry or synopsis, to a more visual, recognition based identification process. In one embodiment, moreover, a visual representation of contents relating to the search subject may include a Uniform Resource Locator (URL), or more generally a Uniform Resource Identifier (URI), enabling user 138 to navigate to the web location of the contents.

Continuing with step 360 of flowchart 300, step 360 comprises applying a time stamp to the viewing pane to produce the web snapshot. The time stamp, which may correspond to the time at which the web search resulting in production of the web snapshot was performed, for example, may be applied by web snapshot application 112. In one embodiment, the time stamp may appear as a visual cue apparent to user 138 on the viewing pane. In other embodiments, however, the time stamp may be included as a data tag, transparent to user 138, but available for use in archiving and retrieving the web snapshot. As a result user 138 can save the web snapshot locally, for example, on client computer 130, and compare that snapshot to others produced at an earlier or later time.

As mentioned previously in reference to FIG. 1, in some embodiments, web snapshot application 112 may be configured to enable user 138 to implement a method for surveying a plurality of web snapshots sharing a common search subject more or less concurrently. In embodiments corresponding to that configuration of web snapshot application 112, the present method may further comprise steps of grouping and organizing web snapshots after their production, as well as supporting storage and retrieval of the grouped web snapshots, for example. As a result, web snapshots sharing a common search subject might be enjoyed collectively, rather than individually. Consequently, those embodiments of the present method may be advantageously utilized by user 138 to rapidly scan the change in media interest and/or coverage of the shared search subject over time.

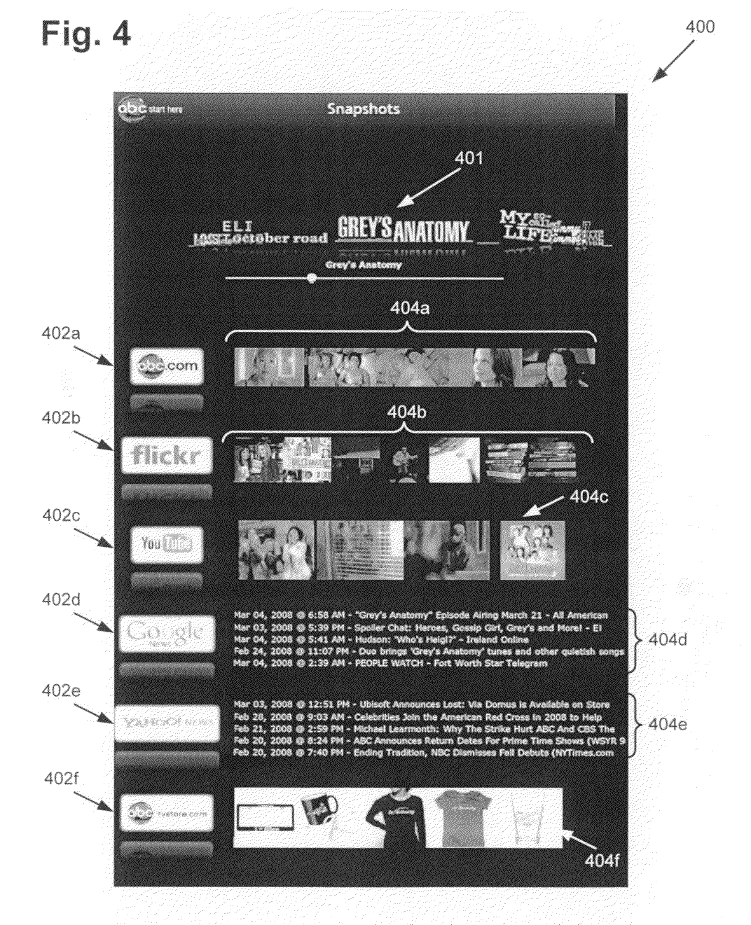

Turning now to FIG. 4, FIG. 4 shows an exemplary viewing pane of a web snapshot capturing contents relating to the ABC television program Grey's Anatomy, produced according to one embodiment of the present invention. Example viewing pane 400, in Figure, features the freshest contents relating to search subject 401 available on the web at the time the web snapshot is produced. Those contents have been obtained from content sources 402a, 402b, 402c, 402d, 402e, and 402f, corresponding to content sources 102a and 102b, in FIG. 1. As may be seen from FIG. 4, the content sources from which the contents used to compose viewing pane 400 is drawn comprise a plurality of commercial web search engines including flickr 402b, YouTube 402c, Google 402d, and Yahoo 402e. The present embodiment also draws contents from commercial entertainment website ABC.com 402a, as well as merchandising website 402f affiliated with ABC television.

Pulling from those multiple content sources, viewing pane 400 shows contents relating to Grey's Anatomy spanning a variety of presentation formats. Shown are sets of visual representations 404a, 404b, 404c, 404d, 404e, and 404f, of contents found on respective content sources 402a through 402f. Those contents comprise video content 404a and 404c, graphical images 404b, text feeds 404d and 404e, and merchandising content 404f. As shown in FIG. 4, composition of viewing pane 400 to include visual representations 404a through 404f results in the presentation of content enabling rapid and intuitive identification of fresh, timely contents likely to be of interest to the user.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. It should also be understood that the invention is not limited to the particular embodiments described herein, but is capable of many rearrangements, modifications, and substitutions without departing from the scope of the invention.

What is claimed is:

1. A method for producing a web snapshot, the method comprising:
determining a search subject from a received input;
designating a plurality of content sources on which to search for contents relating to the search subject;
executing a respective search protocol for finding the contents on each of the plurality of content sources;
selecting the contents found on each of the plurality of content sources according to a time associated with each of the contents;
composing a viewing pane including a visual representation and a location for each of a predetermined number of the selected contents from each of the plurality of content sources; and
applying a time stamp to the viewing pane to produce the web snapshot.

2. The method of claim 1, wherein the designated plurality of content sources comprises a plurality of commercial web search engines.

3. The method of claim 2, wherein executing the respective search protocol for finding the contents comprises submitting key data to respective application programming interfaces provided by the plurality of commercial web search engines.

4. The method of claim 1, wherein the designated plurality of content sources comprises at least one commercial entertainment website.

5. The method of claim 1, wherein executing the respective search protocol for finding the contents comprises exercising direct control over a web spider local to a system for producing the web snapshot.

6. The method of claim 1, wherein the contents comprise a variety of presentation formats including text feeds, graphical images, and video content.

7. The method of claim 1, wherein selecting the contents comprises ranking the contents according to how recently each of the contents was created or updated.

8. A computer-readable medium having stored thereon instructions comprising a web snapshot application which, when executed by a client computer, perform a method comprising:
determining a search subject from a received input;
designating a plurality of content sources on which to search for contents relating to the search subject;
executing a respective search protocol for finding the relevant content on each of the plurality of content sources;
selecting the contents found on each of the plurality of content sources according to a time associated with each of the contents;
composing a viewing pane including a visual representation and a location for each of a predetermined number of the selected contents from each of the plurality of content sources; and
applying a time stamp to the viewing pane to produce the web snapshot.

9. The computer-readable medium of claim 8, wherein the plurality of content sources designated by the web snapshot application comprises a plurality of commercial web search engines.

10. The computer-readable medium of claim 8, wherein executing the respective search protocol for finding the contents comprises submitting key data to respective application programming interfaces provided by the plurality of commercial web search engines.

11. The computer-readable medium of claim 8, wherein the plurality of content sources designated by the web snapshot application comprises at least one commercial entertainment website.

12. The computer-readable medium of claim 8, wherein executing the respective search protocol for finding the contents comprises exercising direct control over a web spider local to a system for producing a web snapshot.

13. The computer-readable medium of claim 8, wherein the contents comprise a variety of presentation formats including text feeds, graphical images, and video content.

14. The computer-readable medium of claim 8, wherein selecting the contents comprises ranking the contents according to how recently each of the contents was created or updated.

15. A system for producing a web snapshot, the system comprising:
a web snapshot search server configured to search multiple sources of web content through a packet network;
a web snapshot application configured to communicate with the web snapshot search server, the web snapshot application further configured to:
determine a search subject matter;
designate a plurality of content sources on which to search for contents relating to the search subject matter;
in combination with the web snapshot search server, execute a respective search protocol to find the contents on each of the plurality of content sources;
select the contents found on each of the plurality of content sources according to a time associated with each of the contents;
compose a viewing pane including a visual representation and a location for each of a predetermined number of the selected contents from each of the plurality of content sources; and
apply a time stamp to the viewing pane to produce the web snapshot.

16. The system of claim 15, further comprising a web spider under the direct control of the web snapshot application.

17. The system of claim 15, wherein the web snapshot application executes as a server based application.

18. The system of claim 15, further comprising a client computer.

19. The system of claim 18, wherein the presentation control application executes as a desktop application on the client computer.

20. The system of claim 18, wherein the client computer comprises a client-side system selected from the group consisting of a personal computer, a mobile telephone, a personal digital assistant (PDA), a gaming console, and a digital media player.
